(19) United States
(12) Patent Application Publication
(10) Pub. No.: US 2016/0141125 A1
(43) Pub. Date: May 19, 2016

(54) CONTROL DEVICE AND METHOD FOR CONTROLLING PHYSICAL SWITCH

(71) Applicant: Institute For Information Industry, Taipei (TW)

(72) Inventors: Shih-Yao DAI, Taipei City (TW); Joey Jenhui SYU, Nantou City (TW); Hui-I HSIAO, Yuanchang Township (TW)

(21) Appl. No.: 14/600,158

(22) Filed: Jan. 20, 2015

(30) Foreign Application Priority Data
Nov. 18, 2014 (TW) 103139881

(51) Int. Cl. H01H 13/14; G08C 17/02

(52) U.S. Cl. CPC H01H 13/14; G08C 17/02; G08C 2201/30; G08C 2201/50

(57) ABSTRACT

A control device and a control method for controlling a physical switch are provided. The control device includes a bonding interface, a signal transceiving module, a control module and a driving module. The bonding interface is configured to bond the control device with the physical switch. The signal transceiving module is configured to receive a control signal. The control module is connected with the signal transceiving module and configured to generate a driving signal according to the control signal. The driving module is connected with the control module and configured to touch and control the physical switch according to the driving signal. The control method is applied to the control device to implement the operations.

### PRIORITY

This application claims priority to Taiwan Patent Application No. 103139881 filed on Nov. 18, 2014, which is hereby incorporated by reference in its entirety.

### FIELD

The present invention relates to a control device and a control method. In particular, the present invention relates to a control device and a control method for controlling a physical switch.

### BACKGROUND

To satisfy users' needs for remote control, remote control technologies have been applied to various fields. For example, a user may turn on various household electrical appliances through remote control technologies before he or she goes back home; or the user may operate his or her office computer through remote control technologies. However, certain switching on household electrical appliances, office computers or other electronic apparatuses must be controlled through physical touch (e.g., through a conventional touch-type physical switch) so that it is difficult to control the switching through conventional remote control technologies. On the other hand, in real world circumstances, there are certain apparatuses that can only be controlled through physical touch, and it is difficult to control such apparatuses through conventional remote control technologies.

Accordingly, it is important in the art to provide a remote control method for apparatuses that can only be controlled through physical touch.

### SUMMARY

An objective of the present invention includes providing a remote control method for an apparatus which can only be controlled through physical touch.

To achieve the aforesaid objective, certain embodiments of the present invention include a control device for controlling a physical switch. The control device comprises a bonding interface, a signal transceiving module, a control module and a driving module. The bonding interface is configured to bond the control device with the physical switch. The signal transceiving module is configured to receive a control signal. The control module is connected with the signal transceiving module, and is configured to generate a driving signal according to the control signal. The driving module is connected with the control module and is configured to touch and control the physical switch according to the driving signal.

To achieve the aforesaid objective, certain embodiments of the present invention include a control method for controlling a physical switch. The control method is used in a control device. The control device comprises a bonding interface, a signal transceiving module, a control module and a driving module. The control device is bonded with the physical switch via the bonding interface. The control method comprises the following steps:

receiving a control signal by the signal transceiving module;

generating a driving signal by the control module according to the control signal; and

touching and controlling the physical switch by the driving module according to the driving signal.

According to the above descriptions, the present invention provides a control device and a control method for controlling a physical switch. In particular, by means of a bonding interface, the control device can be bonded with a physical switch. By means of a signal transceiving module, the control device can receive a control signal from a user. By means of a control module, the control device can generate a driving signal according to the control signal. By means of the driving module, the control device can touch and control the physical switch according to the control signal. Through the aforesaid operations, the present invention allows apparatuses, which can be controlled by a physical switch, to be remotely controlled. In other words, the present invention allows the apparatuses, which can only be controlled through physical touch, be remotely controlled as well.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

A brief description of the attached drawings is proved as follows, but is not to limit the present invention. The attached drawings are described below.

FIG. 1 is a schematic structural view of a control device according to an embodiment of the present invention.

FIG. 2 is a schematic view illustrating the operation of a driving module of the control device.

FIG. 3 is a schematic view illustrating an application of the control device in an Internet of Things (IOT).

FIG. 4 is a schematic view of a control method according to an embodiment of the present invention.

### DETAILED DESCRIPTION

In the following description, the present invention will be explained with reference to example embodiments thereof. However, these example embodiments are not intended to limit the present invention to any specific examples, embodiments, environment, applications, steps, process or particular implementations described in these example embodiments. Therefore, the description of these example embodiments is only for the purpose of illustration rather than to limit the present invention.

In the following embodiments and attached drawings, elements unrelated to the present invention are omitted from depiction. The dimensional relationships among individual elements in the attached drawings are illustrated only for ease of understanding, but not to limit the actual scale.

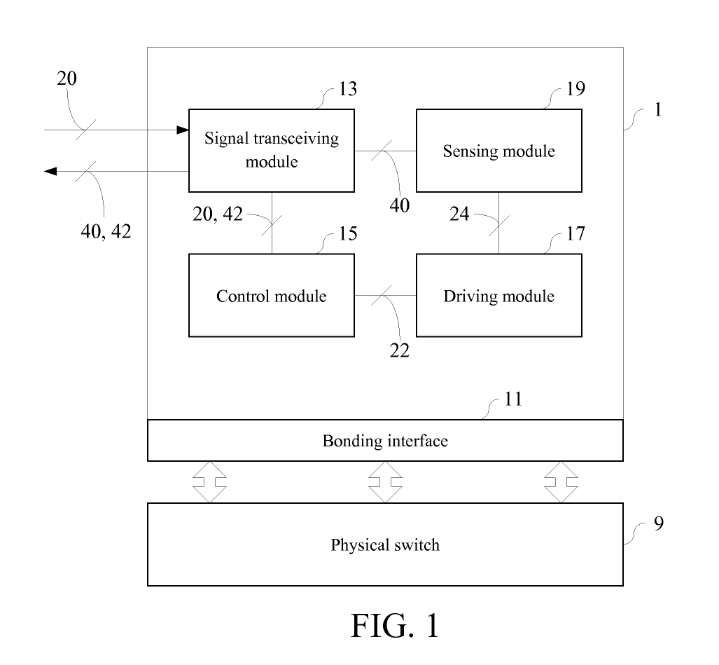

An embodiment of the present invention (briefly called a first embodiment) is a control device for controlling a physical switch. FIG. 1 is a schematic structural view of the control device. As shown in FIG. 1, the control device 1 may comprise a bonding interface 11, a signal transceiving module 13, a control module 15 and a driving module 17. Optionally, the control device 1 may also comprise a sensing module 19. The bonding interface 11, the signal transceiving module 13, the control module 15, the driving module 17 and the sensing module 19 can connect and communicate among each other directly or indirectly.

The bonding interface 11 is configured to bond the control device 1 with at least one physical switch 9 (i.e., one or a plurality of physical switches). In other words, the control device 1 may be bonded with the physical switch 9 via the bonding interface 11. For physical switches 9 of different types, the bonding interface 11 may have different forms. For example, a suitable bonding interface 11 may be selected according to the disposition location, the appearance, the material, the specification, the structures or the like of the physical switch 9. Additionally, the way in which the bonding interface 11 and the physical switch 9 are bonded together is not limited. For example, they may be bonded together through adhesion, magnetic attraction, locking, welding, fastening or the like. In this embodiment, the physical switch 9 refers to any physical switch which can be operated through physical touch.

The signal transceiving module 13 is configured to receive a control signal 20. According to different applications, the signal transceiving module 13 may be a wireless signal transceiving module, a wired signal transceiving module or a combination thereof. The signal transceiving module 13 is preferred to be a wireless signal transceiving module, and is configured to receive a wireless control signal 20 according to various radio communication protocols, e.g., the Wireless Fidelity (Wi-Fi), the Bluetooth, the Infrared Ray or the like. After having received the control signal 20, the control module 15 may generate a driving signal 22 according to the control signal 20. Then, the driving module 17 may touch and control the physical switch 9 according to the driving signal 22.

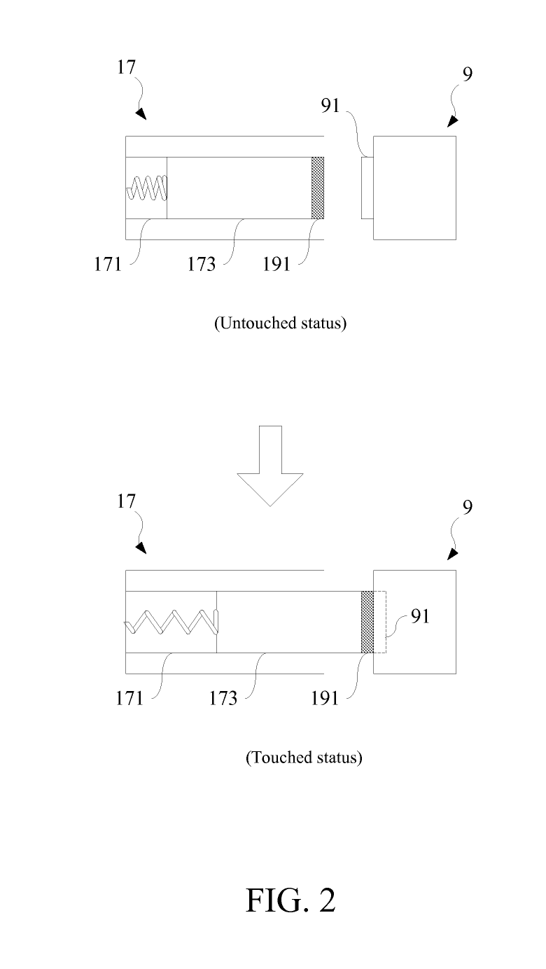

For physical switches 9 of different types, the driving module 17 may have different forms as well. For example, a suitable driving module 17 may be selected according to the disposition location, the appearance, the material, the specification, the structures or the like of the physical switches 9. For example, if the physical switch 9 is a push-type switch, the driving module 17 may comprise an element with a pushing function. If the physical switch 9 is a knob-type switch, the driving module 17 may comprise an element with a knob function. If the physical switch 9 is a pull-type switch, the driving module 17 may comprise an element with a pulling function. Hereinafter, FIG. 2 will be taken as an example for explanation; however, contents shown in FIG. 2 are not intended to limit the present invention.

FIG. 2 is a schematic view illustrating the operations of the driving module 17. As shown in FIG. 2, the physical switch 9 is a push-type switch comprising a button 91. A protruding status of the button 91 indicates that the physical switch 9 is not turned on; and a depressed status of the button 91 indicates that the physical switch 9 is turned on. To touch and control the physical switch 9 correctly, the driving module 17 depicted in FIG. 2 may comprise a transmission element 171 and a piston element 173. The transmission element 171 may drive the piston element 173 according to the driving signal 20 generated by the control module 15 to touch the button 91 of the physical switch 9. Thus, the physical switch 9 is controlled through the operations.

The appearances of the transmission element 171 and the piston element 173 may change according to different applications. As an example, FIG. 2 shows that the transmission element 171 may comprise a transmission rod and an elastic piece (e.g., a spring), and the piston element 173 may comprise a piston rod. Before the driving signal 20 is generated by the control module 15, the piston rod does not touch the button 91 so that the physical switch 9 is not turned on. When the driving signal 20 is generated by the control module 15, the elastic element is released so that the piston rod is driven to the button 91 by the transmission rob. Thus, the physical switch 9 is turned on. The method in which the driving module 17 drives physical switches 9 of other types (e.g., a knob-type switch, a pull-type switch or the like) can be readily known by persons of ordinary skill in the art according to the contents shown in FIG. 2, and thus, will not be further described herein.

In a case where the control device 1 comprises the sensing module 19, the sensing module 19 may sense a touching force 24 generated when the driving module 17 touches and controls the physical switch 9 and may generate an acknowledgement (ACK) signal 40 according to the touching force 24. Then, the signal transceiving module 13 may transmit the ACK signal 40 to an electronic device so that the electronic device determines the status of the physical switch 9 according to the ACK signal 40. The signal transceiving module 13 may comprise a soft piezoresistance sensing element 191 and may be disposed on an end surface, which is used for touching the button 91, of the driving module 17 to sense the touching force 24 generated when the driving module 17 touches and controls the physical switch 9.

As an example, FIG. 2 shows that the soft piezoresistance sensing element 191 may be disposed on the front end surface (i.e., the end surface used to touch the button 91) of the piston element 173, and the sensing module 19 may generate an ACK signal 40 according to the touching force 24 sensed by the soft piezoresistance sensing element 191. For example, after having sensed the touching force 24, the soft piezoresistance sensing element 191 may transmit a sensing signal (not depicted) to the sensing module 19 accordingly. Then, the sensing module 19 can know the level of the touching force 24 (e.g., the level of the pressure value) sensed by the soft piezoresistance sensing element 191 according to the sensing signal, and compare the touching force 24 with a preset threshold to determine whether the physical switch 9 is touched effectively. If the touching force 24 is higher (or lower) than the preset threshold, the sensing module 19 determines that the physical switch 9 is touched effectively, and thereby, generates an ACK signal 40 accordingly. Thus, the information carried by the ACK signal 40 indicates that the physical switch 9 has been touched effectively. Otherwise, if the touching force 24 is lower (or higher) than the preset threshold, the sensing module 19 determines that the physical switch 9 is not touched effectively, and thereby, generates the ACK signal 40 accordingly. Thus, the information carried by the ACK signal 40 indicates that the physical switch 9 has not been touched effectively. In this way, when an electronic device receives the ACK signal 40 from the signal transceiving module 13, it can determine the status (which includes determining whether the physical switch 9 is effectively touched) of the physical switch 9 according to the information carried by the ACK signal 40.

Optionally, the control module 15 may be further configured to create an operation log 42 of the control device 1, and the operation log 42 may be configured to record history operation data of the control device 1. Additionally, the signal transceiving module 13 may also be configured to transmit the operation log 42 to a terminal server system so that the terminal server system analyzes the historical operations of the control device 1 according to the operation log 42. Furthermore, the signal transceiving module 13 can also determine various user behaviors corresponding to the control device 1 from the historical operations.

The control device 1 may be used in various communication environments. However, for the purpose of simplicity, the control device 1 used in an Internet of Things (IOT) will be taken as an exemplary example hereinafter. In other embodiments, the control device 1 may also be used in other communication environments than the IOT.

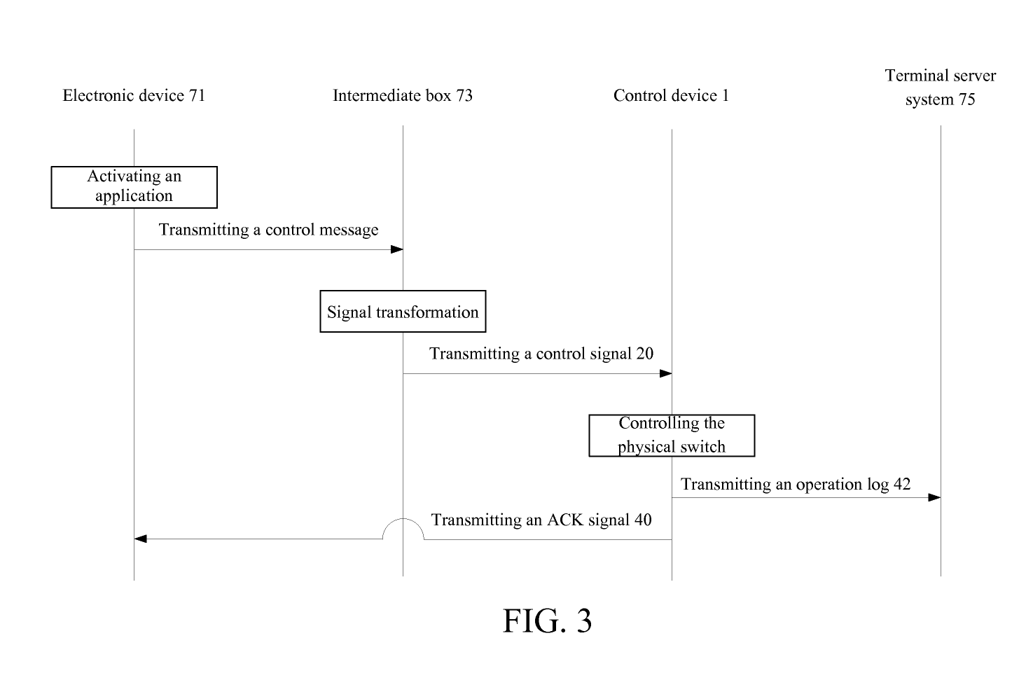

FIG. 3 is a schematic view of the control device 1 used in an IOT. As shown in FIG. 3, a user may activate an application on an electronic device 71. The electronic device 71 may be but not limited to: a hand-held device, a desktop computer, a notebook computer, a tablet computer or the like. Depending on the application, the electronic device 71 may transmit a control message to an intermediate box 73 of an Internet of Things (IOT) via any communication method (e.g., the Internet). In other embodiments, the electronic device 71 may also transmit the control message to a distributor firstly, and then the control message is transmitted to one or more intermediate boxes 73 by the distributor. Each of the intermediate boxes 73 may be a home proxy, which is configured to transform the control message into a control signal 20 suitable for an IOT, and transmit the control signal 20 to the signal transceiving module 13 of the control device 1.

As described above, the control device 1 may generate a driving signal 22 according to the control signal 20 and touch and thereby, control the physical switch 9 according to the driving signal 22. Additionally, the control device 1 may sense a touching force 24 generated when the driving module 17 touches and controls the physical switch 9, and generate an ACK signal 40 according to the touching force 24. Then, the control device 1 may transmit the ACK signal 40 to the electronic device 71 so that the electronic device 71 can determine the status of the physical switch 9 according to the ACK signal 40. Optionally, the control device 1 may transmit the ACK signal 40 to the electronic device 71 via the intermediate box 73, or transmit the ACK signal 40 to the electronic device 71 in other communication ways. On the other hand, the control device 1 may create an operation log 42 which is configured to record the historical operation data thereof, and transmit the operation log 42 to a terminal server system 75. Then, the terminal server system 75 can analyze the historical operations of the control device 1 according to the operation log 42, and know various user behaviors corresponding to the control device 1 from the historical operations.

Another embodiment of the present invention (briefly called a second embodiment) is a control method for controlling a physical switch. The control method is used in a control device. The control device comprises a bonding interface, a signal transceiving module, a control module and a driving module. The control device is bonded with the physical switch via the bonding interface.

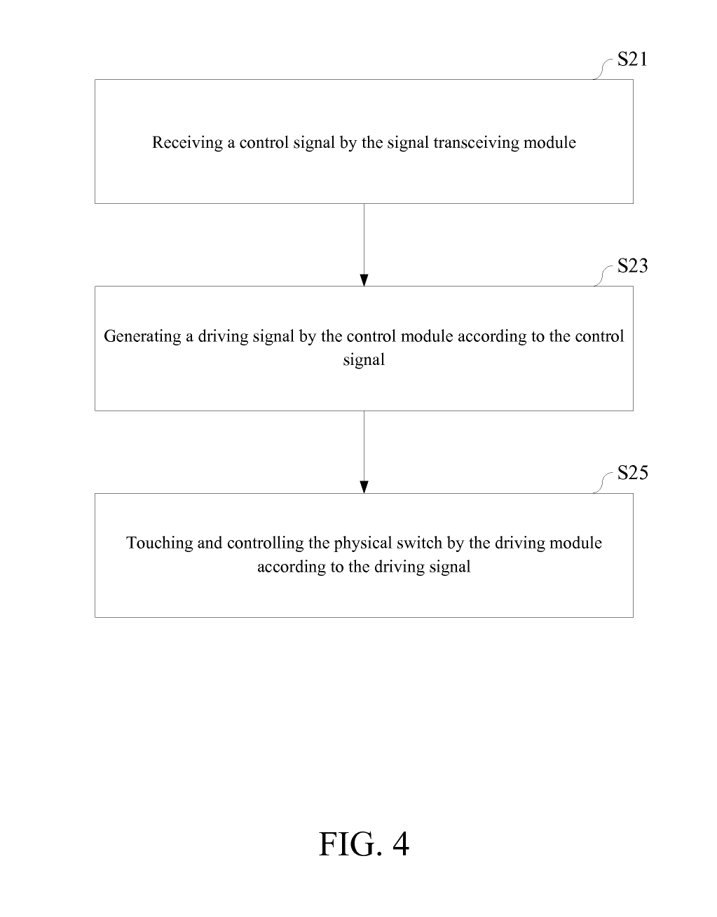

FIG. 4 is a schematic view of the control method. As shown in FIG. 4, the control method comprises the following: receiving a control signal by the signal transceiving module (step S21); generating a driving signal by the control module according to the control signal (step S23); and touching and controlling the physical switch by the driving module according to the driving signal (step S25). The bonding interface, the signal transceiving module, the control module and the driving module in the steps S21, S23 and S25 may substantially correspond to the bonding interface 11, the signal transceiving module 13, the control module 15 and the driving module 17 of the previous embodiments, respectively. Additionally, the order of the steps S21, S23 and S25 is not intended to limit the present invention, and it may be adjusted appropriately without departing from the spirit of the present invention.

As an exemplary example of this embodiment, the control device may further comprise a sensing module. The sensing module may substantially correspond to the sensing module 19 of the previous embodiments. Additionally, the control method may further comprise the following steps:

sensing a touching force generated when the driving module touches and controls the physical switch and generating an ACK signal according to the touching force by the sensing module; and

transmitting the ACK signal to an electronic device by the signal transceiving module so that the electronic device determines a status of the physical switch according to the ACK signal.

As an exemplary example of this embodiment, the driving module further comprises a transmission element and a piston element. The transmission element and the piston element may substantially correspond to the transmission element 171 and the piston element 173 of the previous embodiments. Additionally, the step S25 may further comprise the following step:

driving the piston element by the transmission element according to the driving signal so as to touch and control the physical switch.

As an exemplary example of this embodiment, the signal transceiving module may receive the control signal from an electronic device via an intermediate box of an Internet of Things (IOT).

As an exemplary example of this embodiment, the control method may further comprise the following steps:

creating an operation log of the control device by the control module; and

transmitting the operation log to a terminal server system by the signal transceiving module so that the terminal server system analyzes the control device according to the operation log.

According to the above descriptions, the present invention provides a control device and a control method for controlling a physical switch. In particular, by means of a bonding interface, the control device can be bonded with a physical switch. By means of a signal transceiving module, the control device can receive a control signal from a user. By means of a control module, the control device can generate a driving signal according to the control signal. By means of the driving module, the control device can touch and control the physical switch according to the control signal. Through the aforesaid operations, the present invention allows apparatuses, which can be controlled by a physical switch, to be remotely controlled. In other words, the present invention allows the apparatuses, which can only be controlled through physical touch, to be remotely controlled.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A control device for controlling a physical switch, comprising:
a bonding interface, being configured to bond the control device with the physical switch;
a signal transceiving module, being configured to receive a control signal;
a control module electrically connected with the signal transceiving module, being configured to generate a driving signal according to the control signal; and
a driving module electrically connected with the control module, being configured to touch and control the physical switch according to the driving signal.

2. The control device of claim 1, further comprising a sensing module, wherein the sensing module is connected with the driving module and is configured to sense a touching force generated when the driving module touches and controls the physical switch, and to generate an acknowledgement (ACK) signal according to the touching force; and the signal transceiving module is further configured to transmit the ACK signal to an electronic device so that the electronic device determines a status of the physical switch according to the ACK signal.

3. The control device of claim 1, wherein the driving module further comprises a transmission element and a piston element, and the transmission element drives the piston element according to the driving signal so as to touch and control the physical switch.

4. The control device of claim 1, wherein the signal transceiving module receives the control signal from an electronic device via an intermediate box of an Internet of Things (IOT).

5. The control device of claim 1, wherein the control module is further configured to create an operation log of the control device; and the signal transceiving module is further configured to transmit the operation log to a terminal server system so that the terminal server system analyzes the control device according to the operation log.

6. A control method for controlling a physical switch, the control method being used in a control device, the control device comprising a bonding interface, a signal transceiving module, a control module and a driving module, and the control device being bonded with the physical switch via the bonding interface, the control method comprising:
receiving a control signal by the signal transceiving module;
generating a driving signal by the control module according to the control signal; and
touching and controlling the physical switch by the driving module according to the driving signal.

7. The control method of claim 6, wherein the control device further comprises a sensing module, and the control method further comprises the following steps:
sensing a touching force generated when the driving module touches and controls the physical switch and generating an ACK signal according to the touching force by the sensing module; and
transmitting the ACK signal to an electronic device by the signal transceiving module so that the electronic device determines a status of the physical switch according to the ACK signal.

8. The control method of claim 6, wherein the driving module further comprises a transmission element and a piston element, and the step of touching and controlling the physical switch comprises the following step:
driving the piston element by the transmission element according to the driving signal so as to touch and control the physical switch.

9. The control method of claim 6, wherein the signal transceiving module receives the control signal from an electronic device via an intermediate box of an Internet of Things (IOT).

10. The control method of claim 6, further comprising the following steps:
creating an operation log of the control device by the control module; and
transmitting the operation log to a terminal server system by the signal transceiving module so that the terminal server system analyzes the control device according to the operation log.
